(19) United States
(12) Patent Application Publication
(10) Pub. No.: US 2025/0104217 A1
(43) Pub. Date: Mar. 27, 2025

(54) IMAGE-BASED PREDICTION METHOD FOR POTENTIAL RISK FACTORS IN SEMICONDUCTOR LAYOUT AND COMPUTING DEVICE PERFORMING THE SAME

(71) Applicant: SAMSUNG ELECTRONICS CO., LTD., Suwon-si (KR)

(72) Inventors: Bo Gyeong Kang, Suwon-si (KR); Ye Ji Kim, Suwon-si (KR); Min-Chul Park, Suwon-si (KR); Byoung Seon Choi, Suwon-si (KR); Seong Ryeol Kim, Suwon-si (KR); Young-Gu Kim, Suwon-si (KR); Jae Myung Choe, Suwon-si (KR)

(21) Appl. No.: 18/784,343

(22) Filed: Jul. 25, 2024

(30) Foreign Application Priority Data
Sep. 26, 2023 (KR) 10-2023-0129194
Dec. 29, 2023 (KR) 10-2023-0196951
Jun. 3, 2024 (KR) 10-2024-0072553

(51) Int. Cl. G06T 7/00; G06V 10/44; G06V 10/75; G06V 10/762

(52) U.S. Cl. CPC G06T 7/0008; G06V 10/44; G06V 10/751; G06V 10/758; G06V 10/762; G06T 2207/30148

(57) ABSTRACT

A computing device of predicting potential predicting potential defect-inducing factors within a semiconductor layout is provided. The computing device comprising: a machine learning module, calculating predicted measurement data corresponding to at least one first semiconductor layout image among a plurality of semiconductor layout mages after being trained based on the plurality of semiconductor layout images and corresponding real measurement data and an image explanation module generating an attribution map image of the predicted measurement data based on an image regression model utilizing an integrated gradient (IG) manner, analyzing the attribution map image and detecting elements within the attribution map image with attribution values with high sensitivity to the predicted measurement data as potential defect-inducing factors in advance.

### CROSS-REFERENCE TO RELATED APPLICATION

This application claims priority to Korean Patent Applications No. 10-2023-0129194, filed on Sep. 26, 2023, No. 10-2023-0196951, filed on Dec. 29, 2023, and No. 10-2024-0072553, filed on Jun. 3, 2024, under 35 U.S.C. 119, the contents of which are herein incorporated by reference.

### BACKGROUND

Semiconductor devices are designed using a variety of multiple layout patterns. Even when layout engineers design semiconductor devices based on design rules, due to the complexity of processes and the characteristics of different production equipment or vehicles), previously unrecognized defect elements may be discovered at the stage of processing, and semiconductor devices that include defects or suffer performance degradation due to unknown causes not detected as defect elements can be produced. This leads to a decrease in the yield of semiconductor devices.

Therefore, if potential defect elements or unknown causes affecting other characteristics can be defined in advance and reflected in design rules, it is possible to reduce the trial and error of layout engineers at the stage of layout design and contribute to the improvement of semiconductor yield by blocking risk factors in advance.

By using the knowhow of engineers and measurement databases, potential defect-inducing elements can be identified and defined in advance. However, if too many factors are unnecessarily defined, the difficulty of analysis increases due to various cases, making it difficult to discover factors that affect measurement data. Additionally, as the combination and complexity of layout patterns increase due to the increased design/process difficulty, it becomes difficult to identify which area or element of each pattern affects measurement data.

### SUMMARY

Aspects of the present disclosure provide a method of predicting potential risk factors in a semiconductor layout, which can improve the yield of semiconductor devices by visualizing factors that affect measurement data based on images and thereby enabling the prediction of potential risk factors in advance.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a computing device comprising a machine learning module, calculating predicted measurement data corresponding to at least one first semiconductor layout image among a plurality of semiconductor layout images after being trained based on the plurality of semiconductor layout images and corresponding real measurement data and an image explanation module generating an attribution map image of the predicted measurement data based on an image regression model utilizing an integrated gradient (IG) manner, analyzing the attribution map image and detecting elements within the attribution map image with attribution values with high sensitivity to the predicted measurement data as potential defect-inducing factors in advance.

According to the aforementioned implementations of the present disclosure, there is provided a method of predicting potential predicting potential defect-inducing factors within a semiconductor layout, operating in a computing device, comprising calculating, by the computing device, predicted measurement data for at least one first semiconductor layout image among a plurality of semiconductor layout images through machine learning, extracting, by the computing device, an attribution map image of the predicted measurement data based on an integrated gradient (IG) technique, performing, by the computing device, local analysis and global analysis on the attribution map image and detecting, by the computing device, in advance, elements within the attribution map image, with high sensitivity to the predicted measurement data as the potential defect-inducing factors based on the results of the analyses.

According to the other implementations of the present disclosure, there is provided a computing device comprising a memory storing a plurality of semiconductor layout images and real measurement data, a machine learning module performing learning based on the plurality of semiconductor layout images and the real measurement data, and calculating predicted measurement data for a semiconductor layout image to be analyzed, selected from among the plurality of semiconductor layout images and a processor configured to, extracts attribution map images for the predicted measurement data for the semiconductor layout image to be analyzed, based on the presence or absence of lines in layout patterns, performs either a local analysis on each of the attribution map images or a global analysis on all the attribution map images, and detect, in advance, elements related to features with high sensitivity to the predicted measurement data as potential defect-inducing factors.

It should be noted that the effects of the present disclosure are not limited to those described above, and other effects of the present disclosure will be apparent from the following description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects and features of the present disclosure will become more apparent by describing in detail implementations thereof with reference to the attached drawings, in which:

FIG. 1 is a flowchart illustrating an image-based prediction method for potential risk factors in a semiconductor layout according to some implementations of the present disclosure.

FIG. 2 is a conceptual diagram of a computing device implementing the image-based prediction method according to some implementations of the present disclosure.

FIG. 3 is a graph for explaining an image regression model.

FIG. 4 is a block diagram of a computing device according to some implementations of the present disclosure.

FIG. 5 is a block diagram of a computing device according to some implementations of the present disclosure.

FIG. 6 shows attribution map images extracted from the image explanation module 200 for the cases of the presence and absence of lines.

FIG. 7 shows attribution map images for respective channels, extracted from the image explanation module 200 in the line-present mode.

FIG. 8 shows attribution map images for respective channels, extracted from the image explanation module 200 in the line-absent mode.

FIG. 9 shows layout images before and after preprocessing to explain baseline tuning in the image explanation module 200.

FIG. 10 shows attribution map images before and after baseline tuning.

FIG. 11 is a flowchart illustrating a local analysis method for attribution map images according to some implementations of the present disclosure.

FIGS. 12 through 15 depict images obtained by the image explanation module 200 through the channel-specific local analysis of attribution map images.

FIG. 16 is a flowchart illustrating a global analysis method for attribution map images according to some implementations of the present disclosure.

FIG. 17 is a flowchart illustrating how to extract a plurality of attribution map images for the global analysis method of FIG. 16.

FIG. 18 is a graph showing the distribution of critical dimensions.

FIG. 19 is a detailed flowchart illustrating the global analysis method of FIG. 16.

FIG. 20 illustrates a semiconductor layout including a patch to be analyzed according to some implementations of the present disclosure.

FIG. 21 is a graph showing the statistics of attribution values for the patch of FIG. 20.

FIG. 22 shows how to set patches to be analyzed in a horizontal direction (or an X-axis direction). FIG. 23 is a graph for explaining the trend of patch pooling for the target patches of FIG. 22.

FIG. 24 shows how to set patches to be analyzed in a vertical direction (or a Y-axis direction) according to some implementations of the present disclosure.

FIG. 25 is a graph for explaining the trend of patch pooling for the patches of FIG. 24.

FIG. 26 is a flowchart illustrating a clustering analysis method for attribution map images according to some implementations of the present disclosure.

FIG. 27 is a graph clustering embedded attribution map images by label values.

FIG. 28 show layout-attribution map images displaying attributions for each label value from FIG. 27.

FIG. 29 is a flowchart illustrating how to use analysis results according to some implementations of the present disclosure.

### DETAILED DESCRIPTION

According to implementations of the present disclosure, potential defect elements induced by a semiconductor layout patters can be defined in advance, and the defined potential defect elements can be reflected into design rules at the stage of semiconductor layout design. Circuit design based on improved design rules can reduce trial and error for design engineers while also enhancing the yield of semiconductor devices. A method of predicting potential risk factors in a semiconductor layout according to some implementations of the present disclosure will hereinafter be described.

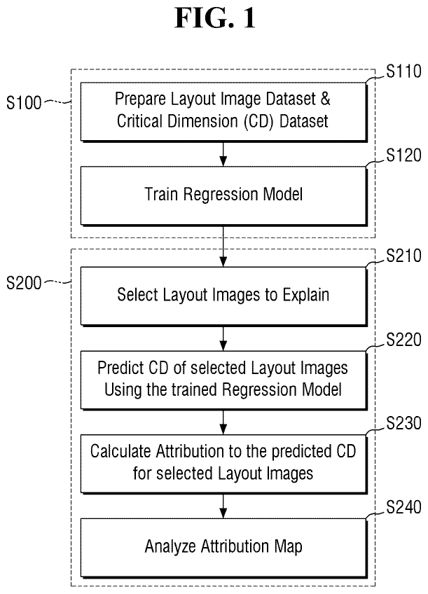

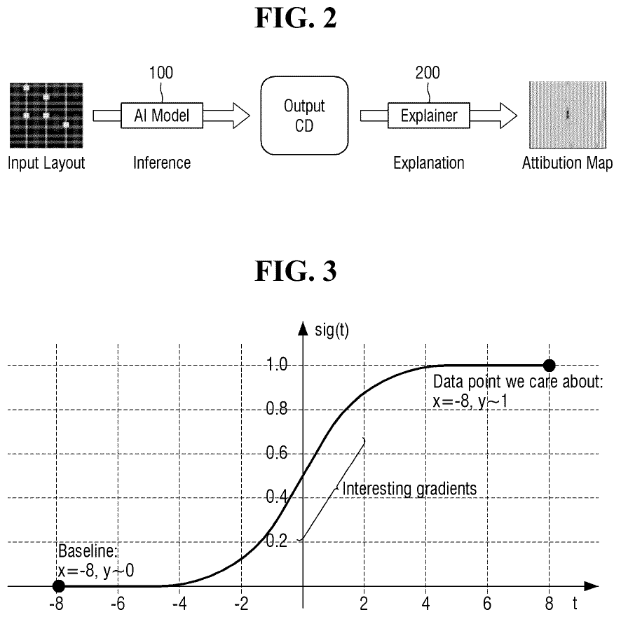

FIG. 1 is a flowchart illustrating an image-based prediction method for potential risk factors in a semiconductor layout according to some implementations of the present disclosure. FIG. 2 is a conceptual diagram of a computing device implementing the image-based prediction method according to some implementations of the present disclosure. FIG. 3 is a graph for explaining an image regression model.

Referring to FIGS. 1 and 2, the image-based prediction method according to some implementations of the present disclosure may be performed by a computing device including a memory device for storing data and a processor for performing operations based on the data. An operation method of the computing device includes a machine learning module 100 and an image explanation module 200. The memory may store data and program codes or software for the machine learning module 100 and the image explanation module 200 and may be executed by the processor.

The computing device performs training of the machine learning module 100 based on a plurality of semiconductor layout images and their corresponding measurement data (S100), and then analyzes newly input semiconductor layout images to detect potential risk factors (S200).

In the machine learning module 100, the computing device first prepares a first data set of semiconductor layout images and a second data set of measurement data (S110) and inputs the first and second data sets into a regression model.

The measurement data corresponds to the prepared semiconductor layout images. The measurement data may refer to, for example, the critical dimension (CD) related to patterns printed on semiconductor wafers, i.e., data that can be generated during the production of semiconductor devices. For example, the measurement data, which is data that can affect the defectiveness/performance of semiconductor devices, includes all data that can quantify structural features such as the width, length, depth, and height of predetermined position structures and their distance or gap from particular neighboring layout patterns.

For example, the computing device stores the first and second data sets in the memory. The image regression model is trained with the first and second data sets received by the processor (S120). The image regression model may define, in advance, potential defect elements induced by semiconductor layout patterns using an eXplainable Artificial Intelligence (XAI) technique. The image regression model may define, in advance, potential defect elements induced by semiconductor layout patterns using an integrated gradient (IG) technique. The IG technique is a type of XAI technique for explaining how much input features have influenced the prediction of a black box model, which describes the relationship between input semiconductor layout patterns and measurement data from semiconductor devices produced with the input semiconductor layout patterns. The IG technique calculates the contribution of each input feature to model prediction as an attribution by considering changes from a particular input to a reference input through integration. The image regression model may be a model capable of performing a back propagation operation to be applicable to an IG method. For example, the image regression model includes a model such as a convolutional neural network (CNN) model.

In the image explanation module 200, the computing device selects a semiconductor layout image from the first data set and also selects the corresponding real measurement data from the second data set (S210). The selected semiconductor layout image may include both an image with a high probability of defects and an image without defects, or may include only the image with a high probability of defects.

The computing device explains the measurement data using the image regression model trained in the machine learning module 100 for each input semiconductor layout image. Referring to FIG. 3, an IG technique-based image regression model may calculate the attribution of the selected semiconductor layout image that contributes to the measurement data (S230), as indicated by Equation 1 below.

$${IG}_{i} ( x ) = ( {x}_{i} - {x}_{i}^{′} ) \times {\int }_{α = 0}^{1} \frac{δ F ( {x}^{′} + α \times ( x - {x}^{′} ) )}{δ {x}_{i}} d α \qquad 〈 Equation 1 〉$$

The image regression model calculates an attribution by accumulating all gradients along the path from a particular baseline to a sample to be explained. In Equation 1, xᵢ denotes an i-th pixel of an i-th input semiconductor layout image, x′ᵢ denotes the baseline of the i-th pixel, and IGᵢ(x) denotes the attribution for the i-th input semiconductor layout image. Equation 1 shows an IG change resulting from the increase of x relative to the baseline for the i-th pixel xᵢ, which is an i-th element of n-dimensional x, meaning the impact of a change in a particular variation on a semiconductor layout. In this specification, an attribution value calculated on a pixel-by-pixel basis may be represented as an image, and a visual representation of pixel-by-pixel contributions of a layout image calculated using the image regression model, as shown in FIG. 2, is referred to as an attribution map. The attribution map image may be represented as an image with attribution pixels marked differently for whether their impact is positive or negative. For example, pixels with an attribution value of 0 may be displayed in a basic color, pixels with a positive impact may be displayed in red, and pixels with a negative impact may be displayed in blue.

The image regression model may extract a final attribution value by calculating and accumulating path gradients for output F(x) on the path changing from the baseline x′ᵢ to input xᵢ. Referring to FIG. 3, if the baseline x′ᵢ is (x, y)=(−8, 0), the IG technique calculates the contribution according to Equation 1, i.e., the attribution IGᵢ(x), by integrating all paths (i.e., interesting gradients) from the baseline x′ᵢ to the input xᵢ, which corresponds to (x, y)=(8, 1). However, if the input xᵢ has the same value as the baseline x′ᵢ (i.e., x′ᵢ=xᵢ), IGᵢ(x)=0, and thus, no attribution is calculated.

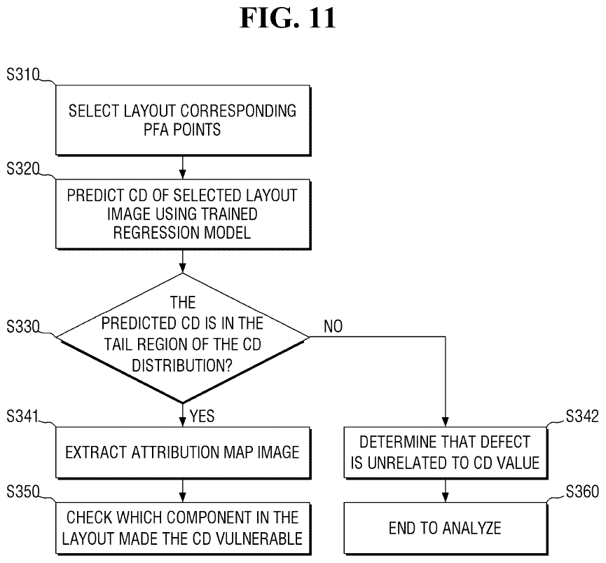

The computing device analyzes the attribution map image derived from the baseline and the input (S240). The attribution map image is the image regression model's result data for the semiconductor layout image selected in step S210. The computing device may perform local analysis by analyzing the attribution map image on a sample-by-sample basis and global analysis by analyzing multiple samples to infer a trend. The analysis of the attribution map image will be described later with FIGS. 11 through 31.

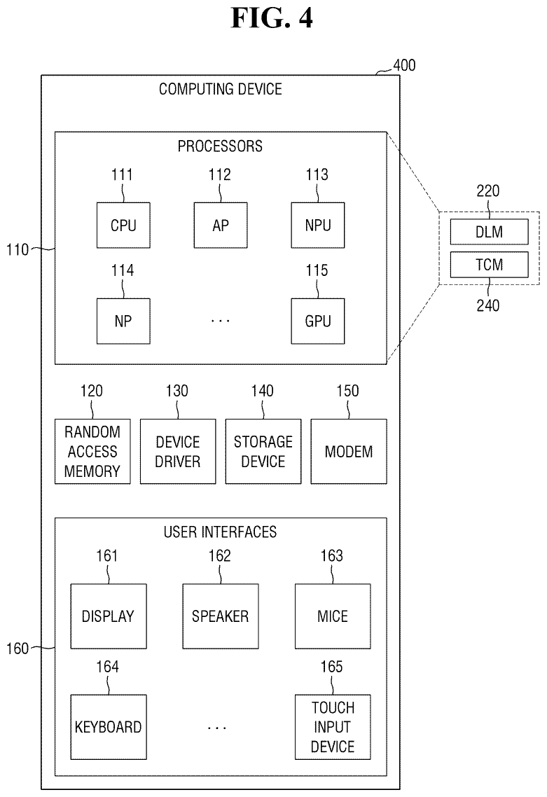

FIG. 4 is a block diagram of a computing device according to some implementations of the present disclosure.

Referring to FIG. 4, a computing device 400 may include processors 110, a random-access memory (RAM) 120, a device driver 130, a storage device 140, a modem 150, and user interfaces 160.

At least one of the processors 110 may execute a deep learning model (“DLM”) 220 and a training control module (“TCM”) 240, which controls the training of the deep learning model 220. The training control module 240 may train the deep learning model 220 by performing the image-based prediction method of FIG. 1. The deep learning model 220 may correspond to the image regression model described above with reference to FIG. 1.

In some implementations, the deep learning model 220 and the training control module 240 may be implemented in the form of instructions (or program codes) executed by at least one of the processors 110. The deep learning model 220 and the training control module 240 may be stored on a computer-readable recording medium. In this case, at least one of the processors 110 may load instructions (or program codes) of the deep learning model 220 and the training control module 240 into the RAM 120.

In some other implementations, at least one of the processors 110 may be manufactured to implement the deep learning model 220 and the training control module 240. For example, at least one of the processors 110 may be manufactured to implement various machine learning modules or deep learning models. At least one of the processors 110 may implement the deep learning model 220 and the training control module 240 by receiving information corresponding to the deep learning model 220 and the training control module 240.

The processors 110 may include, for example, at least one general-purpose processor such as a central processing unit (CPU) 111, an application processor (AP), etc. The processors 110 may also include at least one special-purpose processor such as a neural processing unit 113, a neuromorphic processor 114, a graphics processing unit (GPU) 115, etc. The processors 110 may include two or more processors of the same type.

The RAM 120 may be used as an operational memory for the processors 110 and may serve as the primary memory or system memory of the computing device 400. The RAM 120 may include a volatile memory such as a dynamic random-access memory (DRAM) or a static random-access memory (SRAM) or a non-volatile memory such as a phase-change random-access memory (PRAM), a ferroelectric random-access memory (FeRAM), a magnetic random-access memory (MRAM), or a resistive random-access memory (RRAM).

The device driver 130 may control peripheral devices such as the storage device 140, the modem 150, the user interfaces 160, etc., in response to requests from the processors 110. The storage device 140 may include a fixed storage device such as a hard disk drive (HDD) or a solid-state drive (SSD), or a removable storage device such as an external HDD, an external SSD, a removable memory card, etc.

The modem 150 may provide remote communication with an external device. The modem 150 may perform wireless or wired communication with an external device. The modem 150 may communicate with an external device through at least one of various communication forms such as Ethernet, WiFi, LTE, 5G mobile telecommunications, etc.

The user interfaces 160 may receive information from users and provide information to users. The user interfaces 160 may include at least one user output interface such as a display 161, speakers 162, etc., and at least one user input interface such as a mouse 163, a keyboard 164, a touch input device 165, etc.

The instructions (or program codes) of the deep learning model 220 and the training control module 240 may be received via the modem 150 and stored in the storage device 140. The instructions (or program codes) of the deep learning model 220 and the training control module 240 may be stored in a removable storage device and then coupled to the computing device 400. The instructions (or program codes) of the deep learning model 220 and the training control module 240 may be loaded from the storage device 140 into the RAM 120 for execution.

Computer program instructions, the deep learning model 220, and the training control module 240 may be stored on either a transitory computer-readable medium or a non-transitory computer-readable medium. Moreover, in at least some implementations of the present disclosure, the results of simulations performed by the processors 110 or the values of computational processing performed by the processors 110 may be stored on either a transitory computer-readable medium or a non-transitory computer-readable medium. Furthermore, in at least some implementations of the present disclosure, intermediate values generated during deep learning may be stored on either a transitory computer-readable medium or a non-transitory computer-readable medium. Additionally, in at least some implementations of the present disclosure, training data, process data, device data, simulation result data, prediction data, and uncertainty data may be stored on either a transitory computer-readable medium or a non-transitory computer-readable medium. However, the present disclosure is not limited to these.

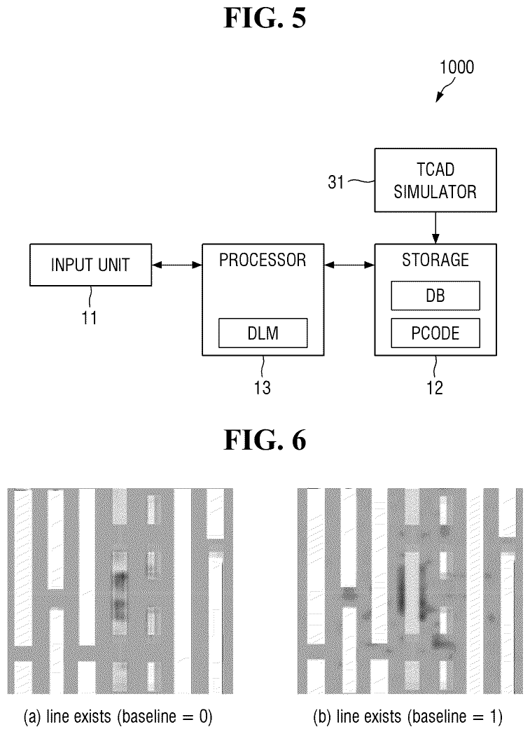

FIG. 5 is a block diagram of a computing device according to some implementations of the present disclosure.

Referring to FIG. 5, a computing device 1000 includes an input unit 11, a storage unit 12, and a processor 13.

The storage unit 12 may store program codes PCODE and a database DB.

The database DB includes basic training data for an existing semiconductor product. A technology computer-aided design (TCAD) simulator 31 may perform simulations based on input data and may provide simulation result data indicating the characteristics of semiconductor devices corresponding to the input data.

The input data 11 may include device data, process data, and measurement data for a semiconductor layout image, as described earlier with reference to FIG. 1. The device data represents the structure and operating conditions of semiconductor devices corresponding to the semiconductor layout image, and the process data may represent the conditions of the manufacturing process for a semiconductor product corresponding to the semiconductor layout image. Each basic training data for a machine learning model (220) corresponds to a combination of process specification data, device specification data, and measurement data corresponding to an existing semiconductor layout image.

The simulation result data may include measurement data and defect information, as described earlier with reference to FIG. 1. For example, the measurement data, which is data that can affect the defectiveness/performance of semiconductor devices, includes all data that can quantify structural features such as the width, length, depth, and height of particular position structures and their distance or gap from particular surrounding layout patterns.

The database DB may include basic training data corresponding to different combinations of the process data, the device data, and the measurement data for an existing semiconductor layout image. For example, the database DB may map and store a semiconductor layout image and real measurement data for the training of a machine learning model, for example a deep learning model DLM (220), and may also map and store predicted measurement data derived from the semiconductor layout image after the training of the machine learning model DLM. The construction of the database DB may be performed by the processor 13, which performs the training of the machine learning model DLM, or by an external processor.

The program codes PCODE may be executed to implement the machine learning module 100 and the image explanation module 200 of FIG. 1. Thus, the program codes for the machine learning module 100 and the image explanation module 200 may be stored on a computer-readable recording medium, i.e., the storage unit 12. In this case, the processor 13 may load the instructions (or program codes) of the machine learning module 100 and the image explanation module 200 into the RAM 120.

The processor 13 may perform training for the machine learning model DLM using the basic training data included in the database DB.

The input unit 11 may receive input data (for example, a layout image) for an existing semiconductor product or a new target semiconductor product based on the basic training data, and may transmit the input data to the processor 13. The processor 13 may input the input data into the trained machine learning model DLM to generate predicted measurement data, representing the characteristics of semiconductor devices included in the existing or target semiconductor product. The predicted measurement data may include information regarding potential defect-inducing factors.

FIG. 6 shows attribution map images extracted from the image explanation module 200 for the cases of the presence and absence of lines.

Referring again to FIG. 1, when a semiconductor layout image to be explained is selected (S210) and measurement data is predicted (S220), the computing device may preprocess the selected semiconductor layout image to properly extract an expected attribution map image corresponding to the selected semiconductor layout image.

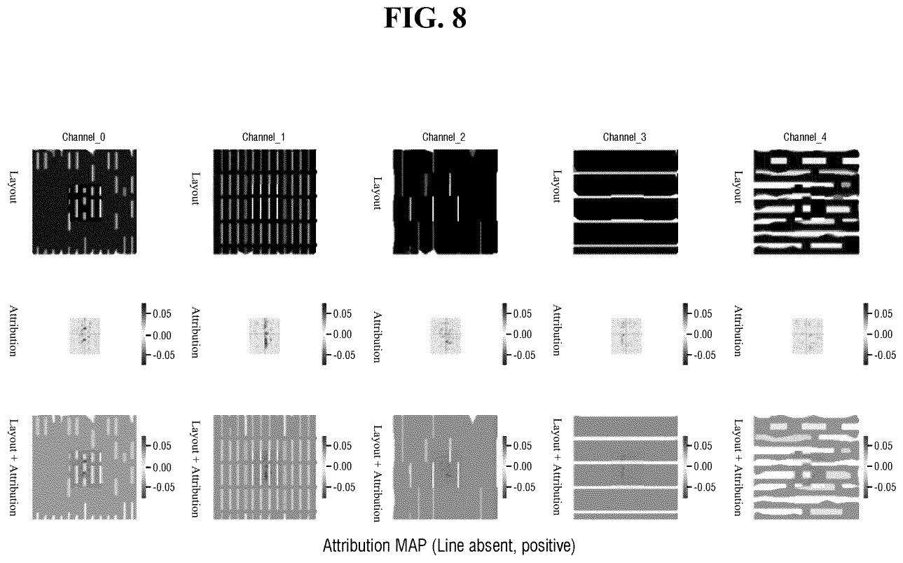

Referring to FIG. 6, the computing device may preprocess a semiconductor layout image in either a line-present mode or a line-absent mode. The semiconductor layout image includes pixels with values in the range [0, 1]. The values of the pixels indicate the presence or absence of layout lines at corresponding locations. A pixel value of 0 means no line-present at a corresponding pixel location, and a pixel value of 1 means a line-present at a corresponding pixel location. The computing device may generate separate attribution map images for the cases of the presence and absence of lines because the impact on measurement data differs when lines are present than when lines are absent. The attribution map images of FIG. 6 show that the distribution of attribution values differs from the line-present mode to the line-absent mode. For example, in the line-present mode, attribution values are distributed at line positions, whereas in the line-absent mode, attribution values are distributed at non-line positions, as shown in attribution map images of FIG. 8.

When lines are present (as shown in image (a) of FIG. 6), the baseline of an image regression model (e.g., x′ᵢ in Equation 1) is set to an image where all pixel values are 0, and attributions are calculated only for line-present parts of the image. In this case, since pixel values (e.g., xᵢ in Equation 1) in line-absent areas of the image are 0, no attribution values are calculated for the line-absent areas of the image. Therefore, the influence on measurement data may be analyzed only for the line-present areas.

Conversely, when lines are absent (as shown in image (b) of FIG. 6), the baseline of the image regression model (e.g., x′ᵢ in Equation 1) is set to an image where all pixel values are 1, and attributions are calculated only for line-absent parts of the image. In this case, since pixel values (e.g., xᵢ in Equation 1) in line-present parts of the image are 0, no attribution values are calculated for the line-present parts of the image. Therefore, the influence on the measurement data may be analyzed only for the line-absent parts.

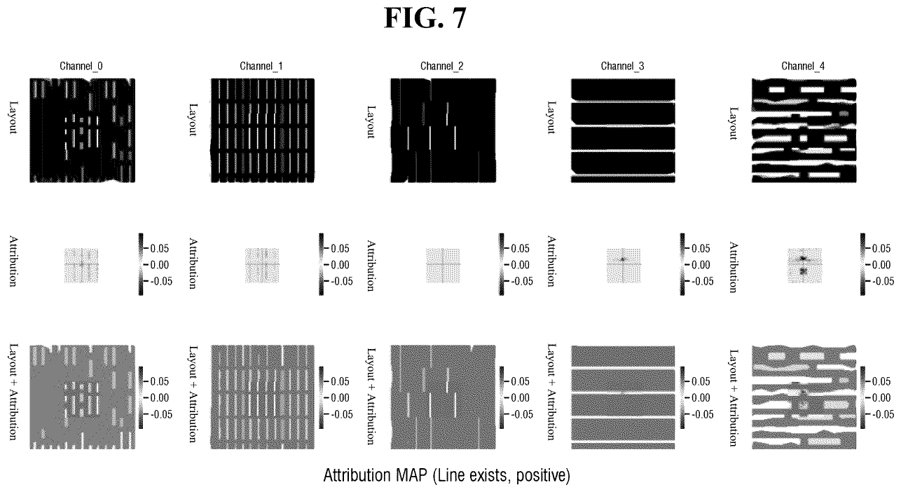

FIG. 7 shows attribution map images for respective channels, extracted from the image explanation module 200 in the line-present mode, and FIG. 8 shows attribution map images for respective channels, extracted from the image explanation module 200 in the line-absent mode.

Referring to FIGS. 7 and 8, in some implementations, the computing device may preprocess a plurality of semiconductor layout image for respective layout channels either in the line-present mode (FIG. 7) or the line-absent mode (FIG. 8), differently from the implementations of FIG. 6.

Attribution map images corresponding to the layout images of different channels may vary. For example, in FIG. 7, the layout image of Channel 0 in the first column has the attribution map image (or a first attribution map image) shown in the second row, and when the layout image and the attribution map image of Channel 0 in the line-present mode are overlaid, as demonstrated in the third row, positive or negative attribution values can be observed in areas overlapped by lines. Conversely, in FIG. 8, the layout image of Channel 0 in the first column has the attribution map image (or the first attribution map image) displayed in the second row, and when the layout image and the attribution map image of Channel 0 in the line-absent mode are overlaid, as shown in the third row, positive or negative attribution values can be observed in areas not overlapped by lines.

However, since the layout image of Channel 1 differs from that of Channel 0, Channel 1 corresponds to an attribution map with a different distribution of attribution values than Channel 0. Similarly, since Channels 2, 3, and 4 have different layout images, the computing device may extract different attribution map images for the layout images of Channels 2, 3, and 4.

Consequently, for the detection of attribution and potential factors, the computing device may extract varying attribution map images from a single layout image based on the presence or absence of lines without the need to separate the single layout image into multiple channels, as shown in FIG. 6. Alternatively, the computing device may divide multiple channels into at least two groups and extract different sets of attribution map images from the layout image of each of the groups based on the presence or absence of lines. Yet alternatively, the computing device may separately extract different sets of attribution map images for each channel based on the presence or absence of lines.

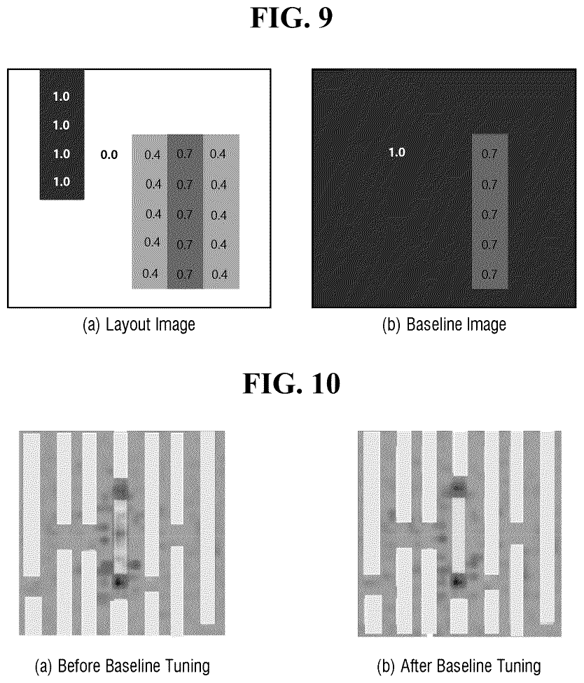

FIG. 9 shows layout images before and after preprocessing to explain baseline tuning in the image explanation module 200, and FIG. 10 shows attribution map images before and after baseline tuning.

When the computing device preprocesses a layout image to extract attribution map images based on the presence or absence of lines, as described in FIGS. 6 through 8, ideally, pixels have a value of 1 in in areas where lines are present and have a value of 0 in areas where lines are absent.

However, as shown in image (a) of FIG. 9, due to a trade-off between resolution and computation load in the process of imaging a semiconductor layout, some of the pixels in the layout image may not have the exact value of 1 or 0, but instead values between 0 and 1 (e.g., 0.4, 0.7, etc.).

When extracting an attribution map image in the line-present mode, it is not problematic for a subsequent attribution map analysis operation in step S240 if pixels where lines are present do not have the exact value of 1, but always have a value greater than 0. However, when extracting an attribution map image in the line-absent mode, there may arise a case where pixels have a non-zero intermediate value (e.g., 0.4) even in line-absent areas, causing confusion in the analysis of an attribution map image in step S240 because it may be interpreted as having an influence on measurement data. Therefore, the computing device may perform baseline tuning to reduce the influence of resolution according to whether being in line-presence or line-absent.

In some implementations, baseline tuning may be performed as indicated by Equation 2 below.

$${x}_{i}^{′} = \{ \begin{matrix}{x}_{linemax} , & if {x}_{linemax} > {th}_{edge} \\ 1 , & if {x}_{linemax} \leq {th}_{edge}\end{matrix} \qquad 〈 Equation 2 〉$$

In Equation 2, xₗᵢₙₑₘₐₓ denotes a maximum pixel value in the row or column where the i-th pixel xᵢ is located, and th_{edge} denotes a threshold pixel value for determining line presence or absence. That is, the computing device may perform tuning by setting the value of the i-th pixel xᵢ to 1 if the maximum pixel value xₗᵢₙₑₘₐₓ is less than or equal to the threshold pixel value th_{edge}, and to 0 if the maximum pixel value xₗᵢₙₑₘₐₓ is greater than the threshold pixel value th_{edge}. For example, when subjected to baseline tuning with the threshold pixel value th_{edge} set to 0.5, the raw layout image (a) of FIG. 9 may produce a baseline-tuned image (b) shown in FIG. 9. Consequently, pixels with a value of 0.4 may be mapped to a value of 1 due to baseline tuning.

Referring to image (a) of FIG. 10, prior to baseline tuning in the line-absent mode, the attribution map image may have fewer attribution values calculated based on line-absent pixels. However, after baseline tuning, as shown in image (b) of FIG. 10, the attribution map image may exhibit a varied count and distribution of attribution values for each tuned line-absent area.

Consequently, in the line-absent mode, the computing device needs to clarify line-absent areas through baseline tuning first and then extract an attribution map image. In this manner, the impact of line-absent pixels on measurement data can be accurately ascertained.

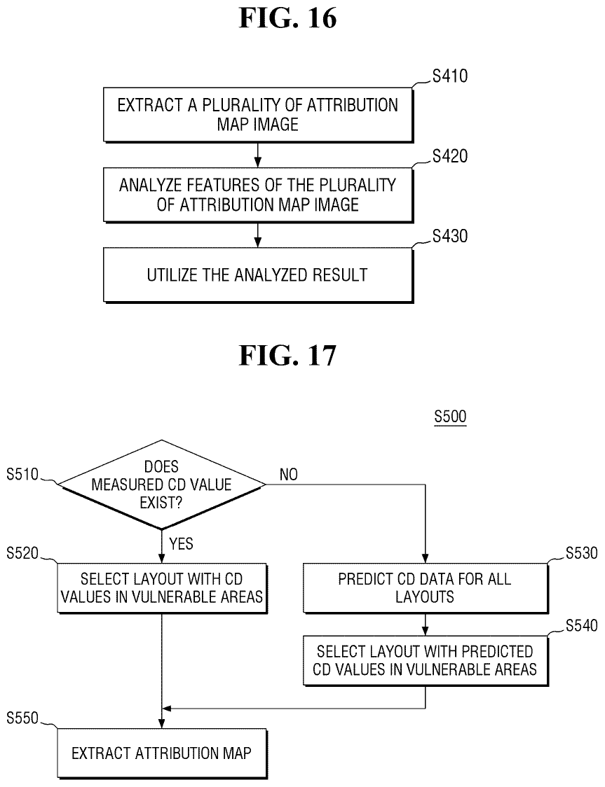

The computing device may analyze preprocessed attribution map images, as previously discussed with reference to FIGS. 6 to 10, employing various methods. For example, the image explanation module 200 may analyze each preprocessed attribution map image individually using a local analysis method, as will be explained with reference to FIGS. 11 through 15. Alternatively, the image explanation module 200 may analyze multiple preprocessed attribution map images using a global analysis method that will be explained with reference to FIGS. 16 through 31.

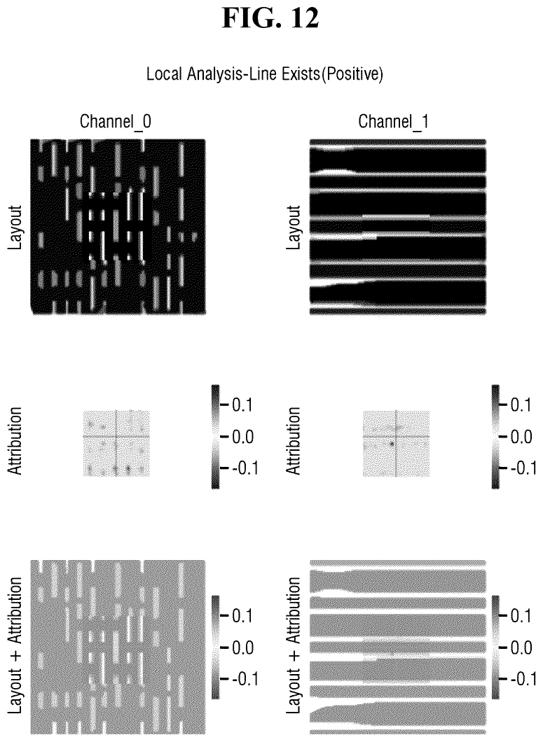

FIG. 11 is a flowchart illustrating a local analysis method for attribution map images according to some implementations of the present disclosure. FIGS. 12 through 15 depict images obtained by the image explanation module 200 through the channel-specific local analysis of attribution map images.

Referring to FIG. 11, the computing device selects a semiconductor layout image that includes physical failure analysis (PFA) points (S310). The trained machine learning module 100 then generates predicted measurement data for the selected semiconductor layout image (S320). When the selected semiconductor layout image contains PFA points, it may be challenging to obtain measurement data as the measurement target structure may already be damaged or not measurable due to destructive inspection processes. However, the trained machine learning module 100 can predict measurement data even for a semiconductor layout image containing PFA points. The predicted measurement data generated by the image explanation module 200 may be displayed as an attribution map image, and information regarding PFA points may be indicated on the attribution map image.

The image explanation module 200 may determine whether predicted measurement data corresponding to PFA points are located in the tail regions (e.g., vulnerable areas or areas with exceptionally high or low measurement data values) of a distribution graph of the overall predicted measurement data. If the predicted measurement data corresponding to PFA points are located in the tail regions (“Yes” in S330), the image explanation module 200 may assume that the characteristics of the PFA points contribute to the predicted measurement data. Consequently, an attribution map image is extracted (S341). Then, the image explanation module 200 may define elements that affect the distribution of the predicted measurement data corresponding to the PFA points as potential defect-inducing factors (S350).

Conversely, if the predicted measurement data corresponding to the PFA points are not located in the tail regions of the distribution graph (“No” in S330), the image explanation module 200 may determine that the characteristics of the PFA points have no relation to the predicted measurement data (S342). In this case, the local analysis method terminates without proceeding to attribution map image extraction (S360).

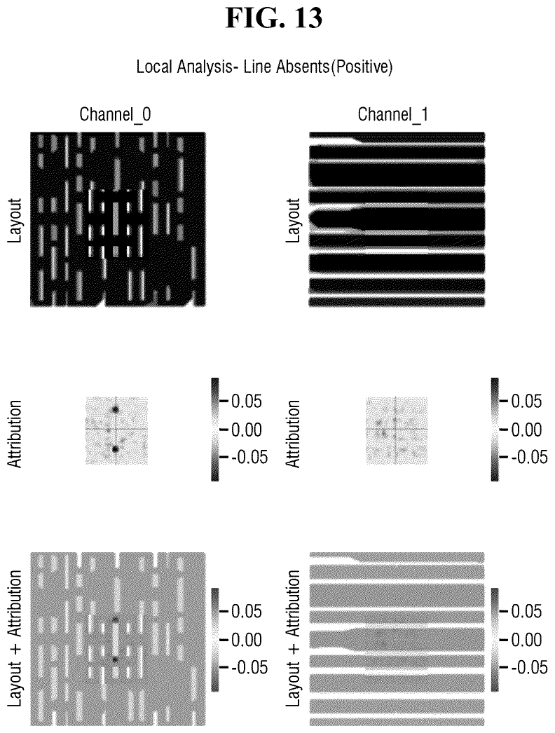

In some implementations, as depicted in FIGS. 12 and 13, which show implementations containing PFA points for the line-present mode and the line-absent mode, respectively, the positive attribution values displayed in the channel-specific attribution map images may be analyzed for each channel. A semiconductor layout image is an image where multiple semiconductor layers are overlaid, with each semiconductor layer containing layout patterns that perform individual, independent functions. For example, a CA layer is a contact mask formed directly over active areas, and a CT layer is a mask cutting gate patterns. In this specification, “channel” denotes the division of a semiconductor layout image by layers. That is, channel-specific analysis involves analyzing layout patterns by classifying the layout patterns into functional units, and the classification of the layout patterns involves classifying the layout patterns into geometric patterns such as vertical patterns, horizontal patterns, or square patterns.

For example, referring to FIG. 12, the attribution map image of Channel 0 exhibits a more intense color distribution of positive attribution values compared to the attribution map image of Channel 1. This may suggest that Channel 0 contains more potential defect-inducing factors than Channel 1, and elements affecting the attribution values of Channel 1 may be identified and defined as potential defect-inducing factors.

Similarly, referring to FIG. 13, the attribution map image of Channel 0 features a distribution of intense red dots, representing attribution values. In this case, elements affecting the distribution of the intense red dots may be identified and defined as potential defect-inducing factors.

Comparing Channel 0′s attribution map images of FIGS. 12 and 13, the attribution values displayed in a vivid color are more concentrated at particular locations in the line-absent mode (FIG. 13) than in the line-present mode (FIG. 12), suggesting that the defect-inducing factors may have a greater impact in the line-absent mode than in the line-present mode.

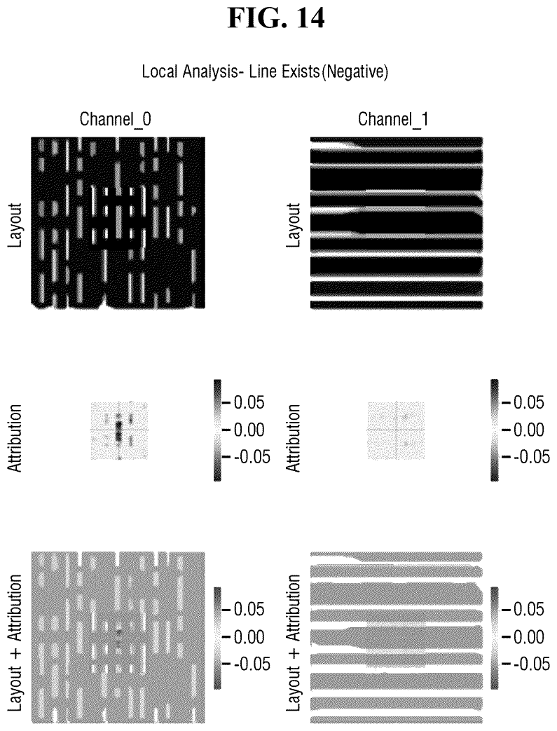

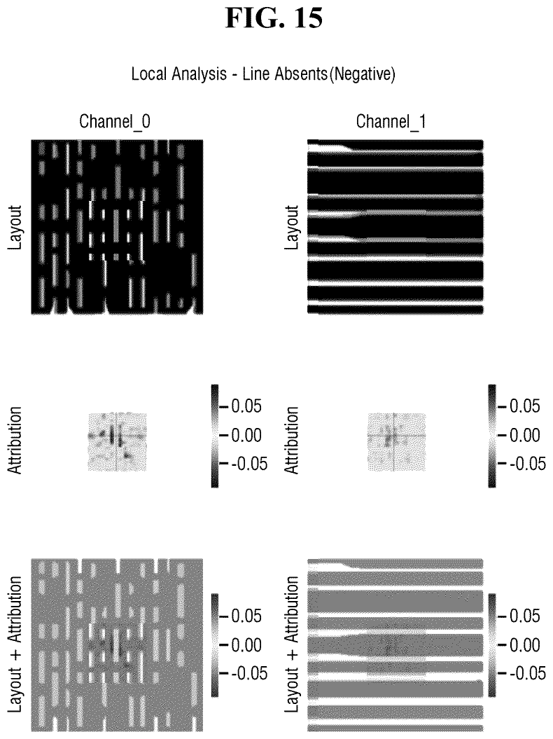

In some implementations, referring to FIGS. 14 and 15, which depict implementations with PFA points, the negative attribution values in the channel-specific attribution map images for the line-present mode (FIG. 14) and the line-absent mode (FIG. 15) may be analyzed for each channel.

Specifically, for example, in the line-present mode of FIG. 14, Channel 0's attribution map image includes a denser, more intensely colored distribution of negative attribution values compared to Channel 1's attribution map image. Similarly, in the line-absent mode of FIG. 15, Channel 0's attribution map image includes a denser distribution of negative attribution values in more vivid colors compared to Channel 1's attribution map image.

In these cases, the negative attribution values, displayed in more vivid colors in Channel 0's attribution map image, are determined to be included in the tail regions in step S330 of FIG. 11. Since defect-inducing factors emerge in adjacent areas in both the line-present mode (FIG. 14) and the line-absent mode (FIG. 15), elements causing such defect-inducing factors may be analyzed separately for each of the line-present mode and the line-absent mode.

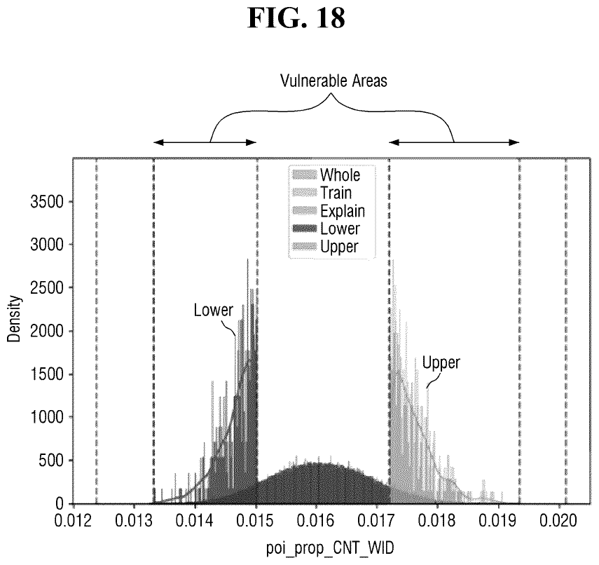

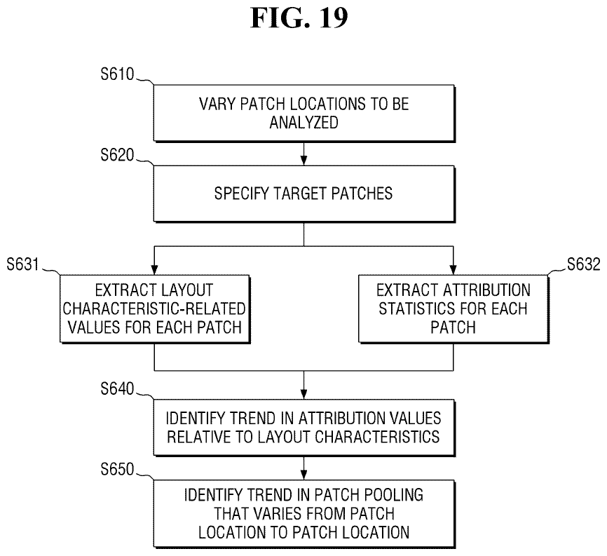

FIG. 16 is a flowchart illustrating a global analysis method for attribution map images according to some implementations of the present disclosure, FIG. 17 is a flowchart illustrating how to extract a plurality of attribution map images for the global analysis method of FIG. 16, FIG. 18 is a graph showing the distribution of critical dimensions, and FIG. 19 is a detailed flowchart illustrating the global analysis method of FIG. 16.

The global analysis method, unlike the local analysis method described above with reference to FIGS. 11 through 15, involves analyzing multiple layout images and their corresponding attribution map images to detect elements within the layout images that make predicted measurement data vulnerable.

Referring to FIG. 16, in some implementations, the image explanation module 200 of the computing device extracts a plurality of attribution map images for global analysis (S410). The computing device then conducts a global analysis to identify a trend in features across the attribution map images (S420) and utilizes the results of the analysis (S430).

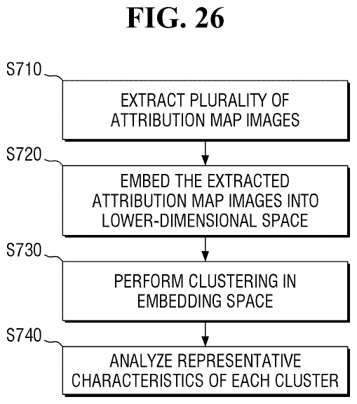

In some implementations, step S420 may be performed using, for example, a patch analysis method that analyzes associations for predefined patch areas (see FIGS. 19 through 25), or a clustering method that groups similar attribution values for analysis (see FIGS. 26 through 31).

In some implementations, step S430 may involve, for example, fixing layout posts, updating design rules based on the analysis results, or improving processing based on elements within the layout images that are identified as making the predicted measurement data vulnerable.

Step S410 may be performed as shown in FIG. 17. Referring to FIG. 17, the method of extracting a plurality of attribution map images may vary depending on the existence of measurement data corresponding to semiconductor layouts (S510).

For example, when there exists measurement data corresponding to semiconductor layouts (“Yes” in S510), the image explanation module 200 of the computing device selects multiple semiconductor layouts corresponding to measurement data in vulnerable areas (S520). Referring to FIG. 18, when the measurement data are densely centered as in, for example, a Gaussian distribution, the vulnerable areas may correspond to lower and upper portions of the distribution of the measurement data. For example, the vulnerable areas may include the measurement data within the lower or upper 5% of the distribution, but the present disclosure is not limited thereto.

If there does not exist measurement data corresponding to semiconductor layouts (“No” in S510), it may be challenging to distinguish the vulnerable areas. Thus, the trained machine learning module 100 predicts measurement data for all the semiconductor layouts (S530), and then selects multiple semiconductor layouts corresponding to predicted measurement data that fall into the vulnerable areas (S540). The computing device extracts the selected multiple semiconductor layouts (S550).

Step S420 may be performed as illustrated in FIGS. 19 to 25. Referring to FIG. 19, patch locations to be analyzed may be variably set in the extracted multiple semiconductor layouts based on the intent of the analysis (S610). That is, in the multiple semiconductor layouts, the locations, sizes, and orientations of patches to be analyzed may be designated. In some implementations, the patches to be analyzed may be areas set in at least one axis of each of the semiconductor layouts, such as a horizontal, vertical, or diagonal direction, and their width, breadth, and shape may be variably set.

Once the image explanation module 200 sets one or more patches to be analyzed according to the intent of the analysis (S620), the image explanation module 200 may extract element values related to the layout characteristics of each of the patches to be analyzed (S631) and statistical values of attribution values within each of the patches to be analyzed (S632). The image explanation module 200 extracts correlations between the element values and statistical values extracted in steps S631 and S632, respectively, for each of the multiple semiconductor layouts. For example, trends in the correlations between the element values from step S631 and the statistical values from step S632 may be identified (S640).

Moreover, the image explanation module 200 may set the patches to be analyzed at different locations in steps S610 and S620, extract element values related to the layout characteristics of each of the patches to be analyzed (S631), and the statistical values of attribution values within each of the patches to be analyzed (S632), and then derive correlations between the extracted element values and statistical values from steps S631 and S632, respectively (and trends of the attribution values from step S632 against the layout characteristics from step S631) (S640).

By changing the patch locations and examining the changing trends of patch pooling according to the patch locations (S650), global analysis results can be obtained.

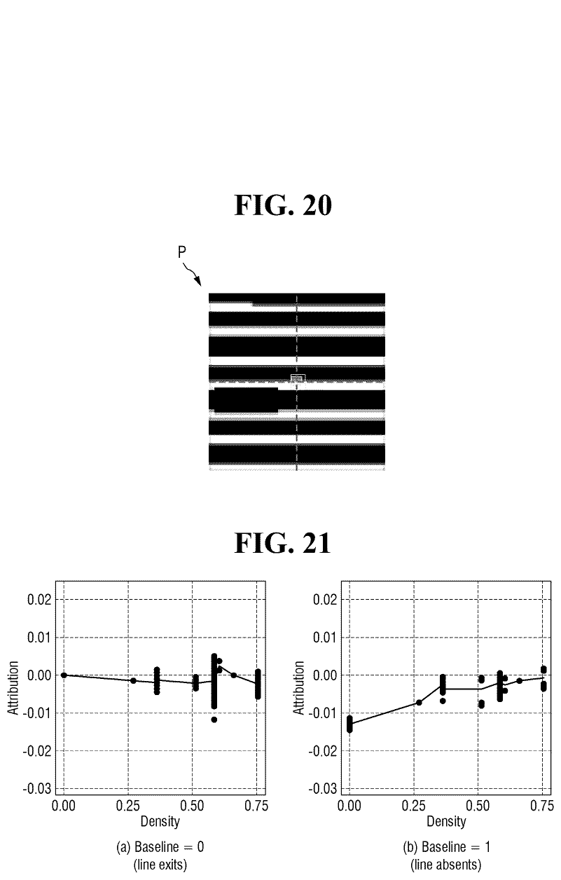

Some implementations of the global analysis method of FIG. 19 will hereinafter be described with reference to FIGS. 20 through 25.

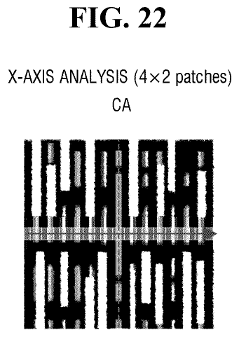

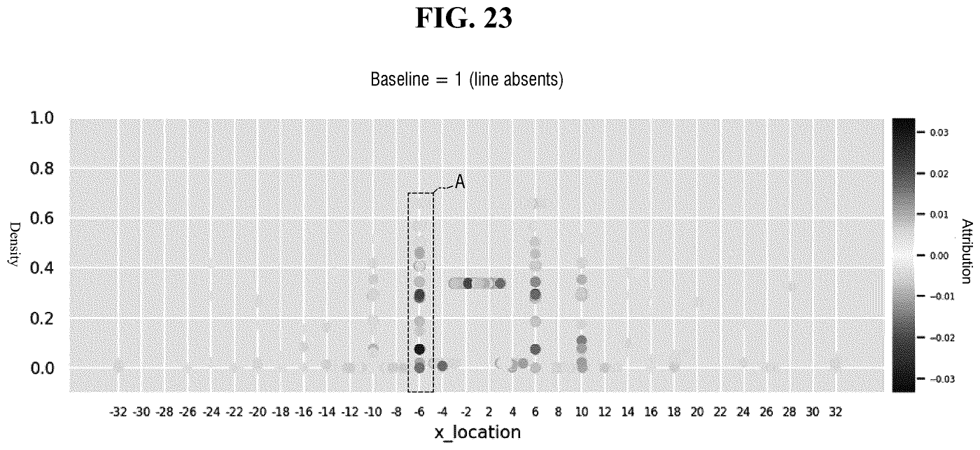

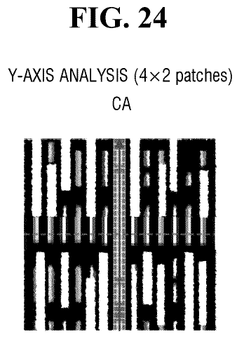

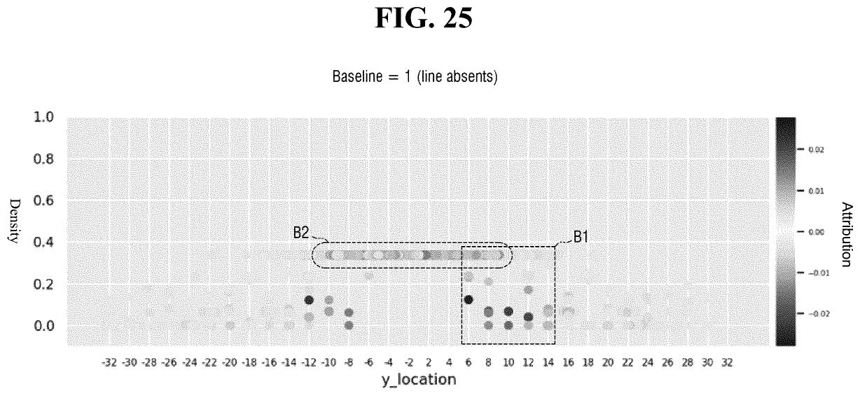

FIG. 20 illustrates a semiconductor layout including a patch to be analyzed according to some implementations of the present disclosure, and FIG. 21 is a graph showing the statistics of attribution values for the patch of FIG. 20. FIG. 22 shows how to set patches to be analyzed in a horizontal direction (or an X-axis direction), and FIG. 23 is a graph for explaining the trend of patch pooling for the target patches of FIG. 22. FIG. 24 shows how to set patches to be analyzed in a vertical direction (or a Y-axis direction) according to some implementations of the present disclosure, and FIG. 25 is a graph for explaining the trend of patch pooling for the patches of FIG. 24.

In the semiconductor layout of FIG. 20, a patch P to be analyzed may be set as an area of a predetermined size (e.g., a 4×4 pixel size), depicted as a box including the center point of the semiconductor layout, as determined in steps S610 and S620. For convenience, the patch P will hereafter be described as including the center point of the semiconductor layout, but may also be another area within the semiconductor layout that needs to be analyzed.

Referring to FIG. 21, the image explanation module 200 generates separate attribution map images for the cases where lines exist below the center point of the semiconductor layout (graph (a)) and where no lines exist below the center point of the semiconductor layout (graph (b)). Then, the image explanation module 200 extracts statistics in step S632 through the distribution graph of attribution values. Referring to the graph (a) of FIG. 21 for the case of the presence of lines, the mean line drawn along the distribution of attribution values in the statistics shows a slight decline, a slight increase, and then a decline again in the attribution values relative to density. In this case, it may be determined that there is no significant trend. However, referring to the graph (b) of FIG. 21 for the absence of lines, the mean line drawn along the distribution of attribution values in the statistics shows an upward linear trend relative to density. Specifically, the attribution values tend to converge from −0.012 to 0. Therefore, in step S640, the image explanation module 200 determines from the graph (b) of FIG. 21 that there is a trend where the absolute values of the attribution values decrease in the absence of lines below the center point.

Referring to FIG. 22, in some implementations, patches in the horizontal direction (or the X-axis direction) may be set in a semiconductor layout. For example, in step S620, rectangular 4×2 patches that are elongated in the horizontal direction (or the X-axis direction), as indicated by an arrow, may be set. Referring to FIG. 23, along with FIG. 22, for a case where “Baseline=1 (Line Absent)” where lines with a trend are absent, as determined from the results of FIG. 22, the image explanation module 200 may identify the distribution of the attribution values from step S632 relative to the horizontal locations from step S631. For example, in step S640, a distribution graph may be extracted by sampling a predetermined number (e.g., 1000) of vulnerable area measurement data, and a trend of decreasing attribution values may be observed at horizontal locations on the extracted distribution graph, such as point A where x_location=−6.

Moreover, referring to FIG. 24, in some implementations, patches in the vertical direction (or the Y-axis direction) may be set in the semiconductor layout. For example, in step S620, rectangular 4×2 patches that are elongated in the vertical direction (or the Y-axis direction), as indicated by an arrow, may be set. Referring to FIG. 25, along with FIG. 24, for a case “Baseline=1 (Line Absent)” where lines with a trend are absent, as determined from the results of FIG. 24, the image explanation module 200 may identify the distribution of the attribution values from step S632 relative to the vertical locations from step S631. For example, in step S640, a distribution graph of the correlations between the vertical locations and the attribution values may be extracted, and a trend of increasing attribution values may be observed at vertical locations from y_location=6 to 14, as indicated by “B1”. At vertical locations between y_location=−12 and 10, near the center (i.e., y_location=0), uniform density within the patches makes it difficult to discern any trend.

The image explanation module 200 can track the trend in attribution values across different patches, as demonstrated in FIGS. 21, 23, and 25. Additionally, in step S650, the image explanation module 200 can quantify features associated with positions along each axis in an attribution map image, particularly where trends are observed.

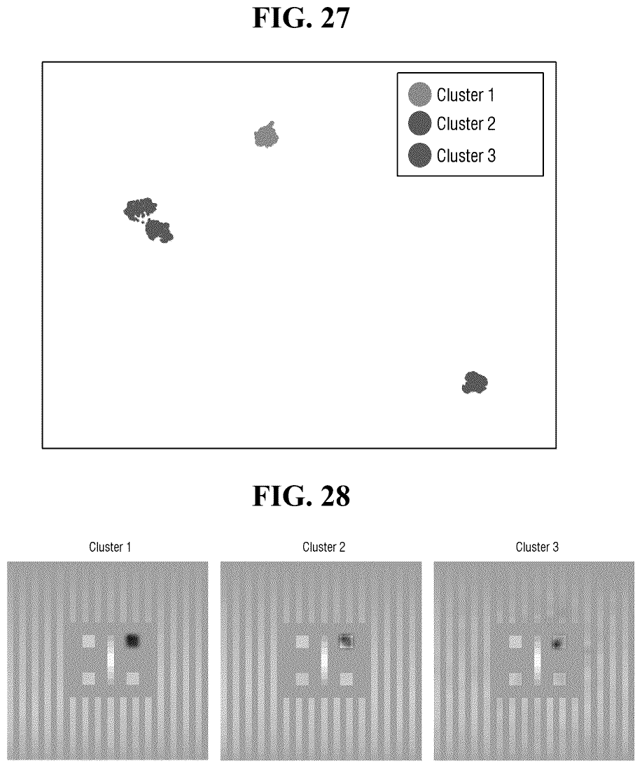

FIG. 26 is a flowchart illustrating a clustering analysis method for attribution map images according to some implementations of the present disclosure, FIG. 27 is a graph clustering the attribution values of the embedded attribution map images by regional distribution, and FIGS. 28 show layout-attribution map images displaying attributions for each label value from FIG. 27.

Alternatively, step S420 of FIG. 16 may be performed as illustrated in FIGS. 26 through 28.

Referring to FIG. 26, the image explanation module 200 extracts a plurality of attribution map images from the vulnerable areas from S410 (S710) and transforms the dimensionality of the extracted attribution map images (S720). For example, attribution map images from the vulnerable areas may be extracted as high-dimensional images (e.g., a 64×64 pixel size) for multiple attributions and may then be embedded into a lower-dimensional space that emphasizes target attributions to be analyzed. The transformation from high-dimensional to lower-dimensional space may be performed by various methods, such as Variational AutoEncoder (VAE), Uniform Manifold Approximation and Projection (UMAP), or t-distributed Stochastic Neighbor Embedding (t-SNE). The lower-dimensional space may be, for example, adjusted as a hyperparameter based on the intent of the analysis. For example, for clustering based on attribution map images, semiconductor layout features may be classified based on those related to measurement data to analyze which features within semiconductor layout patterns affect the measurement data. For example, the lower-dimensional space may be visualized as a graph showing correlations between latent features.

The image explanation module 200 performs clustering on the attribution values displayed in the embedded lower-dimensional space (S730). Clustering may be conducted using various well-known methods, such as Density-Based Spatial Clustering of Applications with Noise (DBSCAN) or k-Nearest Neighbors (K-NN).

Referring to FIG. 27, the image explanation module 200 visualizes the distribution of the attribution values in the lower-dimensional space, with each cluster being assigned a label value. For example, when the label values are set from 1 to 3, the distribution of labels in the lower-dimensional space may be visually identified. The label values 1˜3 are one of the implementations, these are not limited that implementation and able to set various labels. On the other hand, a label value of −1, which does not belong to set-regions 1˜3, is considered noise that does not meet the criteria for clustering.

Referring to FIG. 28, when displaying a “Layout+Attribution” map with a mean attribution value for each label value, the distribution of attributions with the mean attribution value corresponding to a particular label value of, for example, attribution values of each cluster 1˜3, may be represented as a “Layout+Attribution” map. For example, the attribute value area shown as red color in cluster 1 in FIG. 28 has similar distribution with the attribute value area shown as blue color in cluster 2. For example, the red color represents a positive attribute value and the blue color represents a negative attribute value, the attribute value distribution between cluster 1 and cluster 2 are similar so the correlation between cluster 1 and cluster 2 can be analyzed and inferred.

However, the distribution of cluster 3 is sporadic and different from the distribution of attribute values in cluster 1 and cluster 2, so it can be inferred that it is not related to the attribute values shown in cluster 1 or cluster 2.

The image explanation module 200 analyzes the representative characteristics of the attribution values exhibited by each cluster (S740). For example, the representative characteristics may be analyzed and inferred based on the mean values of the attribution values for each cluster.

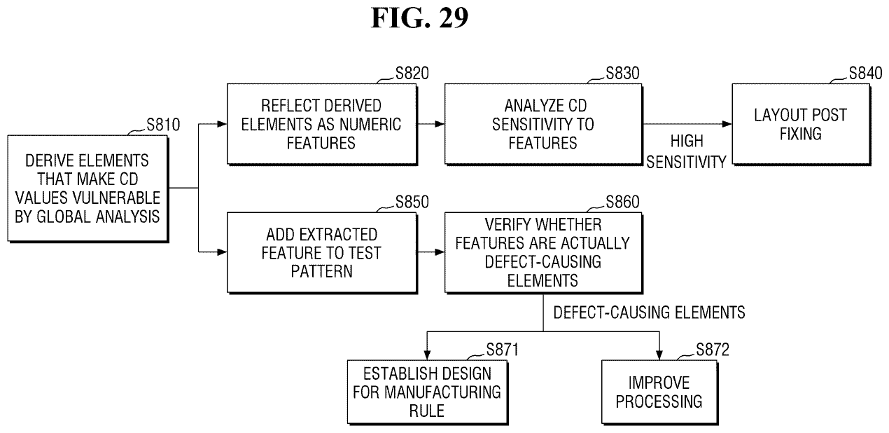

FIG. 29 is a flowchart illustrating how to use analysis results according to some implementations of the present disclosure.

Referring to FIG. 29 and FIG. 16, in step S430 of FIG. 16, once the image explanation module 200 extracts features for each patch or representative characteristics for each cluster from the multiple layout images, as previously described with reference to FIGS. 17 through 28, the computing device may derive elements within the layout patterns that make the measurement data vulnerable from the extracted analysis results (S810).

The computing device may reflect the derived elements as numeric features (S820), and may analyze the sensitivity of the measurement data to changes in the derived elements (S830). For example, numeric features such as the density of attribution values in the layout or the count of mask dropouts (e.g., breaks in the pattern of contacts on an active mask) may be reflected, and the variation or sensitivity of the measurement data to changes in such numeric features may be statistically analyzed or analyzed through machine learning.

Thereafter, the computing device may modify the layout (S840) to reflect elements related to the features (i.e., features in machine learning) that show high sensitivity to the measurement data.

Meanwhile, once the image explanation module 200 extracts features for each patch or representative characteristics for each cluster from the multiple layout images, the computing device may add the extracted features or characteristics to a test pattern before actual product production (S850), and may verify whether the extracted features actually contribute to defects (S860). If the extracted features are deemed to contribute to defects, it may be reflected in the design for manufacturing (DFM) rule (S871), and process causes that prevent the design from being rendered as originally intended can be improved (S872).

The image-based prediction method and the computing device according to some implementations of the present disclosure can improve the yield of semiconductor devices by predicting potential risk factors in advance through attribution images based on measurement data before actual defects occur.

Additionally, by predicting potential risk factors using machine learning based on multiple layout images and corresponding measurement data, it is possible to predict risk factors more objectively and accurately without relying on the subjective experience of engineers, even as the design/process complexity increases with technological advancements. This enables the implementation of cost-effective and efficient exploratory data analysis (EDA) tools for semiconductor devices.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination

While implementations of the present invention have been described with reference to the attached drawings, it should be understood by those skilled in the art that the invention can be embodied in other specific forms without departing from the spirit or essential characteristics thereof. Therefore, the aforementioned implementations should be considered in all respects as illustrative and not restrictive.

What is claimed is:

1. A computing device comprising:
a machine learning module configured to calculate predicted measurement data corresponding to at least one first semiconductor layout image among a plurality of semiconductor layout images, wherein the machine learning module is trained based on the plurality of semiconductor layout images and corresponding real measurement data; and
an image explanation module configured to generate an attribution map image of the predicted measurement data based on an image regression model utilizing an integrated gradient (IG) manner, analyze the attribution map image, and detect one or more elements within the attribution map image with one or more attribution values with sensitivity to the predicted measurement data as one or more potential defect-inducing factors in advance.

2. The computing device of claim 1, wherein the image explanation module is configured to generate at least one of: a line-present-mode attribution map image, or a line-absent-mode attribution map image, according to whether one or more layout pattern lines are presented in the at least one first semiconductor layout image.

3. The computing device of claim 2, wherein the line-absent-mode attribution map image is an attribution map image where a value of an i-th pixel (where i is a natural number) is baseline-tuned to a predefined value by comparing a threshold pixel value with a maximum pixel value, wherein the maximum pixel value is obtained from a row or column where the i-th pixel belongs.

4. The computing device of claim 2, wherein the image explanation module is configured to:
calculate overall predicted measurement data by selecting at least one first semiconductor layout image that contains one or more physical failure analysis (PFA) points;
extract a corresponding attribution map image in response to predicted measurement data for the one or more PFA points being included in one or more vulnerable areas of a distribution of the overall predicted measurement data; and
concluding the analysis of the attribution map image without extracting the attribution map image for the at least one first semiconductor layout image in response to the predicted measurement data for the one or more PFA points being not included in the one or more vulnerable areas.

5. The computing device of claim 4, wherein one or more elements in the extracted attribution map image that influence a distribution of the predicted measurement data for the one or more PFA points are defined as the one or more potential defect-inducing factors.

6. The computing device of claim 2, wherein the image explanation module is configured to:
extract the at least one first semiconductor layout image and multiple attribution map images corresponding to the at least one first semiconductor layout image, and
identify a trend of features in the extracted multiple attribution map images.

7. The computing device of claim 6, wherein the image explanation module is configured to:
calculate the predicted measurement data for all the at least one first semiconductor layout image in response to there being no real measurement data corresponding to the at least one first semiconductor layout image;
select a first semiconductor layout image with predicted measurement data belonging to the one or more vulnerable areas of the distribution of the overall predicted measurement data; and
extract the multiple attribution map images corresponding to the selected first semiconductor layout image.

8. The computing device of claim 6, wherein identifying the trend includes setting a plurality of patch locations to be analyzed in the at least one first semiconductor layout image;
extracting a plurality of element values related to a plurality of characteristics of the at least one first semiconductor layout image at the plurality of set patch locations, and extracting plurality of statistics of the one or more attribution values of the multiple attribution map images at the plurality of set patch locations; and
identifying a trend in correlations between the plurality of element values and the plurality of statistics at the plurality of set patch locations.

9. The computing device of claim 8, wherein identifying the trend further includes
changing the plurality of patch locations to set a plurality of new patch locations; and
identifying a trend in patch pooling that varies according to the plurality of new patch locations.

10. The computing device of claim 6, wherein identifying the trend includes:
embedding the extracted multiple attribution map images into a lower-dimensional space;
clustering one or more attribution values displayed in the embedded low-dimensional space;
visualizing a distribution of the one or more attribution values by assigning a label value to at least two clusters belonged to the one or more attribution values; and
inferring one or more representative characteristics of a plurality of clusters based on an average of the one or more attribution values in a corresponding cluster.

11. A method of predicting potential predicting one or more potential defect-inducing factors within a semiconductor layout, comprising:
calculating, by a computing device, predicted measurement data for at least one first semiconductor layout image among a plurality of semiconductor layout images through machine learning;
extracting, by the computing device, an attribution map image of the predicted measurement data based on an integrated gradient (IG) technique;
performing, by the computing device, local analysis and global analysis on the attribution map image; and
detecting, by the computing device one or more elements within the attribution map image with sensitivity to the predicted measurement data as the one or more potential defect-inducing factors based on one or more results of the local analysis and the global analysis.

12. The method of claim 11, wherein the machine learning includes:
learning one or more correlations between the one or more elements within the plurality of semiconductor layout images and a plurality of real measurement data respectively corresponding to the plurality of semiconductor layout images; and
calculating predicted measurement data for at least one of the plurality of semiconductor layout images.

13. The method of claim 11, wherein the attribution map image is extracted and categorized as a first attribution map image for a line-present mode and a second attribution map image for a line-absent mode based on presence or absence of one or more lines in one or more layout patterns contained in the at least one first semiconductor layout image.

14. The method of claim 11, wherein performing the local analysis includes:
selecting, from the plurality of semiconductor layout images and as an analysis target, at least one semiconductor layout image, wherein the at least one semiconductor layout image contains one or more physical failure analysis (PFA) points; and
extracting the attribution map image for the selected at least one semiconductor layout image in response to predicted measurement data for the one or more PFA points within the selected at least one semiconductor layout image being within one or more vulnerable areas of a distribution of overall predicted measurement data.

15. The method of claim 14, wherein detecting the one or more potential defect-inducing factors includes
identifying one or more attribution values in the extracted attribution map image that have sensitivity to the predicted measurement data for the one or more PFA points; and
detecting one or more elements corresponding to the identified one or more attribution values as the one or more potential defect-inducing factors.

16. The method of claim 11, wherein performing the global analysis includes:
selecting multiple semiconductor layout images corresponding to predicted measurement data that belong to the one or more vulnerable areas;
extracting multiple attribution map images for each of the selected multiple semiconductor layout images; and
analyzing at least one of (i) a trend of the one or more attribution values included in each of the extracted multiple attribution map images on a patch-by-patch basis, or (ii) one or more representative characteristics of each cluster by clustering the one or more attribution values.

17. The method of claim 16, wherein analyzing the one or more representative characteristics of each cluster includes:
embedding the extracted multiple attribution map images into a lower-dimensional space;
clustering the one or more attribution values displayed in the embedded lower-dimensional space;
visualizing a distribution of the one or more attribution values by assigning a label value to each cluster; and
inferring the one or more representative characteristics of each cluster based on an average of the one or more attribution values in a corresponding cluster.

18. A computing device comprising:
a memory storing a plurality of semiconductor layout images and real measurement data;
a machine learning module configured to perform learning based on the plurality of semiconductor layout images and the real measurement data, and configured to calculate predicted measurement data for a semiconductor layout image to be analyzed, wherein the semiconductor layout image to be analyzed is selected from among the plurality of semiconductor layout images; and
a processor configured to,
extract one or more attribution map images for the predicted measurement data for the semiconductor layout image to be analyzed, based on presence or absence of one or more lines in one or more layout patterns,
perform at least one of: a local analysis on each of the one or more attribution map images, or a global analysis on all the attribution map images, and
detect one or more elements related to one or more features with sensitivity to the predicted measurement data as one or more potential defect-inducing factors.

19. The computing device of claim 18, wherein the one or more attribution map images include one or more line-present-mode attribution map images for the presence of the one or more layout pattern lines in the stored semiconductor layout image and one or more line-absent-mode attribution map images for the absence of the one or more layout pattern lines in the stored semiconductor layout image.

20. The computing device of claim 18, wherein performing the global analysis includes:
setting one or more locations, one or more sizes, and one or more orientations of one or more patches to be analyzed;
extracting one or more correlations between one or more element values related to one or more layout characteristics of multiple patches contained in each of the plurality of semiconductor layout images, and extracting one or more statistics of one or more attribution values within the multiple patches, and
analyzing a trend in the one or more element values based on the extracted one or more correlations.
